(19) United States
(12) Patent Application Publication
(10) Pub. No.: US 2025/0264854 A1
(43) Pub. Date: Aug. 21, 2025

(54) PROGRAMMABLE LOGIC CONTROLLER AND CONTROL METHOD

(71) Applicant: Keyence Corporation, Osaka (JP)

(72) Inventor: Tomonobu KITAGAWA, Osaka (JP)

(73) Assignee: Keyence Corporation, Osaka (JP)

(21) Appl. No.: 19/023,526

(22) Filed: Jan. 16, 2025

(30) Foreign Application Priority Data
Feb. 21, 2024 (JP) 2024-024319

(51) Int. Cl. G05B 19/05

(52) U.S. Cl. CPC G05B 19/056; G05B 2219/13101

(57) ABSTRACT

A user program is efficiently switched while operating a PLC. The PLC may include a processor repeatedly executing a logic operation based on the user program, and a memory storing values of variables accessed according to the user program executed by the processor. An instruction is issued to switch to a second user program, which is an updated version of a first user program, while the processor is executing the first user program. Variable information for identifying a variable to be maintained and a variable to be changed by an update from the first user program to the second user program is created. An address in which a value of the variable to be maintained is stored is maintained, and an address in which a value of the variable to be changed is stored is assigned at a break of the logic operation with the logic operation being stopped.

### CROSS-REFERENCE TO RELATED APPLICATIONS

The present application claims foreign priority based on Japanese Patent Application No. 2024-024319, filed Feb. 21, 2024, the contents of which are incorporated herein by reference.

### BACKGROUND OF THE INVENTION

### 1. Technical Field

The invention relates to a programmable logic controller and a control method.

### 2. Description of the Related Art

In factory automation, a programmable logic controller (PLC) is a core controller that controls industrial machines. The PLC controls industrial machines by executing a user program such as a ladder program.

When a certain correction point is found, a user program is changed or a command is added (JP 2001-125608 A).

Meanwhile, it is necessary to stop a PLC in order to switch the user program of the PLC from the user program before the change to a user program after the change. In this case, a production line controlled by the PLC is stopped, which leads to a decrease in operation rate of the production line. On the other hand, there is also a method of switching the user program by temporarily stopping sequence control while operating the PLC. In this case, a stop time of the production line is shortened. However, in a case where a large amount of time is required to construct a relationship between a large number of variables used by the user program and a storage area thereof, as a result, it is difficult to switch the user program while operating the PLC. That is, the larger the scale of the user program, the more difficult it is to rewrite the user program at high speed.

### SUMMARY OF THE INVENTION

Therefore, an object of the invention is to efficiently switch a user program while operating a PLC.

For example, the invention provides a programmable logic controller including:
a processor that repeatedly executes a logic operation based on a user program;
a data memory that stores values of variables accessed according to the user program executed by the processor; and
a memory management unit that maintains an address in the data memory in which a value of a variable to be maintained is stored based on variable information for identifying the variable to be maintained and a variable to be changed by an update from a first user program to a second user program, which is an updated version of the first user program, when an instruction to switch to the second user program is received while the processor is executing the first user program, and stops the logic operation and assigns, at a break of the logic operation, an address in the data memory in which a value of the variable to be changed is stored.

According to the invention, it is possible to efficiently switch the user program while operating the PLC.

### BRIEF DESCRIPTION OF THE DRAWINGS

FIG. 1 is a diagram illustrating a PLC system;

FIG. 2 is a diagram illustrating a PC (setting support apparatus);

FIG. 3 is a diagram illustrating a basic unit;

FIG. 4 is a diagram illustrating a transfer control unit;

FIG. 5 is a flowchart illustrating a method of transferring a project;

FIG. 6 is a flowchart illustrating handling of a global variable;

FIG. 7 is a view illustrating an example of a change of an array;

FIG. 8 is a view illustrating an example of a change of a structure type;

FIG. 9 is a view illustrating instantiation of a function block;

FIG. 10 is a view illustrating an example of a storage area secured in a memory;

FIG. 11 is a view illustrating a storage area of an instance;

FIG. 12 is a view illustrating definition information, a call tree, and an instance ID;

FIG. 13 is a view illustrating definition information, a call tree, and an instance ID;

FIG. 14 is a flowchart illustrating a method of saving a value; and

FIG. 15 is a flowchart illustrating a method of restoring a value.

### DETAILED DESCRIPTION

Hereinafter, an embodiment will be described in detail with reference to the accompanying drawings. Note that the following embodiment does not limit the invention according to the claims, and all combinations of characteristics described in the embodiment are not necessarily essential for the invention. Two or more characteristics of a plurality of characteristics described in the embodiment may be arbitrarily combined. Further, the same or similar configurations are denoted by the same reference numerals, and redundant description will be omitted.

### (1) PLC System

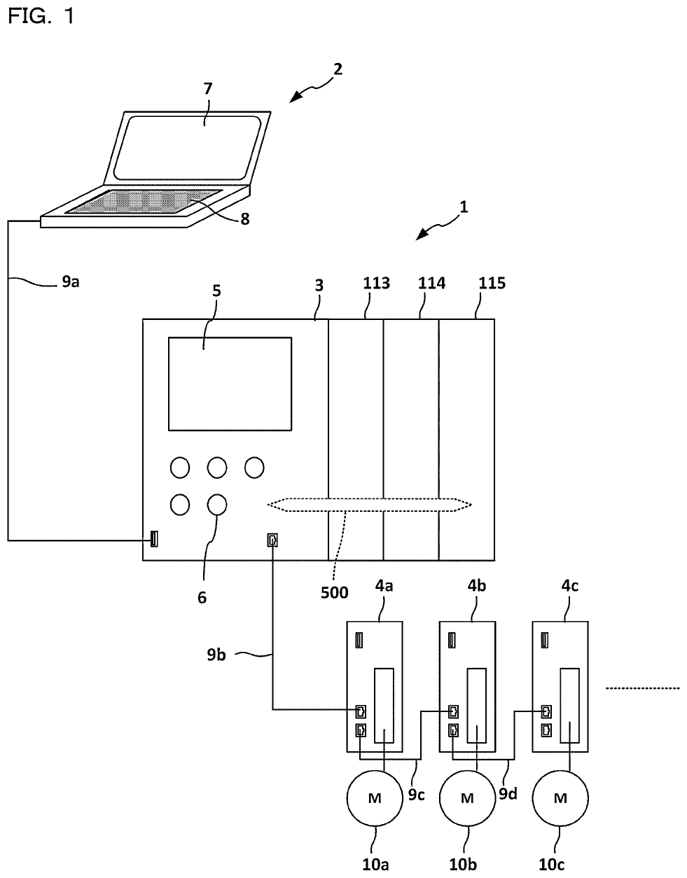

FIG. 1 illustrates a configuration example of a programmable logic controller system (hereinafter, referred to as a PLC system 1) according to the embodiment of the invention. As illustrated in FIG. 1, the PLC system 1 includes: a PC 2 that is a setting support apparatus configured to edit a user program such as a ladder program; a basic unit 3 that is a programmable logic controller (PLC) configured for integrated control of various control apparatuses installed in a factory or the like; and a plurality of expansion units 113 to 115. In the PLC system 1, one or more expansion units 113 to 115 connected via an expansion bus 500 are connected to the basic unit 3. The basic unit 3 is sometimes also referred to as a CPU unit or a main unit. Examples of the expansion units 113 to 115 include various units such as a motion unit, an input unit, an output unit, an input/output unit (I/O unit), an analog conversion unit, and a communication unit. Note that a motion control function, an analog conversion function, and a communication function connected to the expansion bus 500 may be recognized by the basic unit 3 as expansion units built in the basic unit 3. Further, motor drivers 4a to 4c may be connected to the basic unit 3 via an industrial network. The plurality of motor drivers 4a to 4c drive motors 10a, 10b, and 10c, respectively.

The user program created by the PC 2, which is the setting support apparatus, may be created using a graphical programming language such as a ladder language or a flowchart-format motion program, or may be created using a high-level programming language such as ST language or C language.

The basic unit 3 includes a display unit 5 and an operation unit 6. The display unit 5 can display operation statuses of the motor drivers 4a to 4c. The display unit 5 may switch display content according to operation content of the operation unit 6. The display unit 5 normally displays a current value (device value) of a device in the PLC system 1, information on an error (presence or absence of an alarm or warning) occurring in the PLC system 1, and the like. The device is a name indicating an area on a memory provided to store a device value (device data), and may be referred to as a device memory.

The device value is information indicating an input state from input equipment, an output state to output equipment, or a state of an internal relay (auxiliary relay), a timer, a counter, a data memory, or the like set on the user program. Types of the device value include a bit type and a word type. A bit device stores a 1-bit device value. A word device stores a device value of one word.

The motor drivers 4a to 4c are prepared to extend functions of the PLC system 1. The motors 10a to 10c are controlled by the motor drivers 4a to 4c, respectively. The motor drivers 4a to 4c supply electric power to the motors 10a to 10c, and control a rotation amount and the like according to a command from the basic unit 3. Examples of the motors 10a to 10c include a servo motor and a stepping motor.

The PC 2 is a computer that provides a development environment of the PLC system 1. The PC 2 is, for example, a portable notebook type or tablet type personal computer, and includes a display unit 7 and an operation unit 8. The ladder program, which is an example of the user program configured to control the PLC system 1, is created using the PC 2. The created ladder program is converted into a mnemonic code in the PC 2. The PC 2 is connected to the basic unit 3 of the PLC system 1 via a communication cable 9a such as a universal serial bus (USB), and sends the ladder program converted into the mnemonic code to the basic unit 3. The basic unit 3 converts the ladder program into a machine code and stores the machine code in a memory provided in the basic unit 3. Note that the mnemonic code is transmitted to the basic unit 3 here, the invention is not limited thereto. For example, the PC 2 may convert the mnemonic code into an intermediate code and send the intermediate code to the basic unit 3, or may convert the mnemonic code into an object code and send the object code to the basic unit. Further, these may be mixed.

Note that the operation unit 8 of the PC 2 may include a pointing device such as a mouse connected to the PC 2 although not illustrated in FIG. 1. Further, the PC 2 may be configured to be detachably connected to the basic unit 3 via another communication cable 9a other than the USB. Further, the PC 2 may be wirelessly connected to the basic unit 3 without using the communication cable 9a. In this case, the communication cable 9a may be understood to represent a wireless link.

The basic unit 3 and the motor driver 4a are connected by a communication cable 9b, and can perform communication (for example, cyclic communication and message communication) with each other via the communication cable 9b. The motor driver 4a and the motor driver 4b are connected by a communication cable 9c, and can communicate with each other via the communication cable 9c. The motor driver 4b can communicate with the basic unit 3 via the communication cables 9b and 9c. The motor driver 4b and the motor driver 4c are connected by a communication cable 9d, and can communicate with each other via the communication cable 9d. Further, the motor driver 4c can communicate with the basic unit 3 via the communication cables 9b, 9c, and 9d.

Although the motor drivers 4a to 4b are connected in this example, the number of motor drivers 4 may be one or more. Manufacturers of the motor drivers 4a to 4c may be different from each other or the same. Here, it is assumed that the motor drivers 4a to 4c are manufactured by different manufacturers, respectively, for convenience of description.

Hereinafter, the motor drivers 4a to 4c are expressed as motor drivers 4 when common matters are described. Similarly, the motors 10a to 10c are expressed as motors 10 when common matters are described.

The basic unit 3 has a function of executing a sequence control program written in the ladder (LD) language or the ST language. Furthermore, the basic unit 3 of the present embodiment may also have a communication function and a motion control function. The communication function and the motion control function of the basic unit 3 are handled like an expansion unit built in the basic unit 3.

The basic unit 3 and each of the expansion units 113 to 115 of the PLC each execute iterative processing. A timing at which the basic unit 3 executes the program can be matched with a timing at which the expansion units 113 to 115 execute iterative processing, or data exchange can be executed in synchronization. Such a function may be referred to as a so-called “inter-unit synchronization function”. The motion control function and the sequence control function included in the basic unit 3 can also be matched in processing execution timing by the “inter-unit synchronization function”, and data exchange can be executed in synchronization.

### (2) Setting Support Apparatus

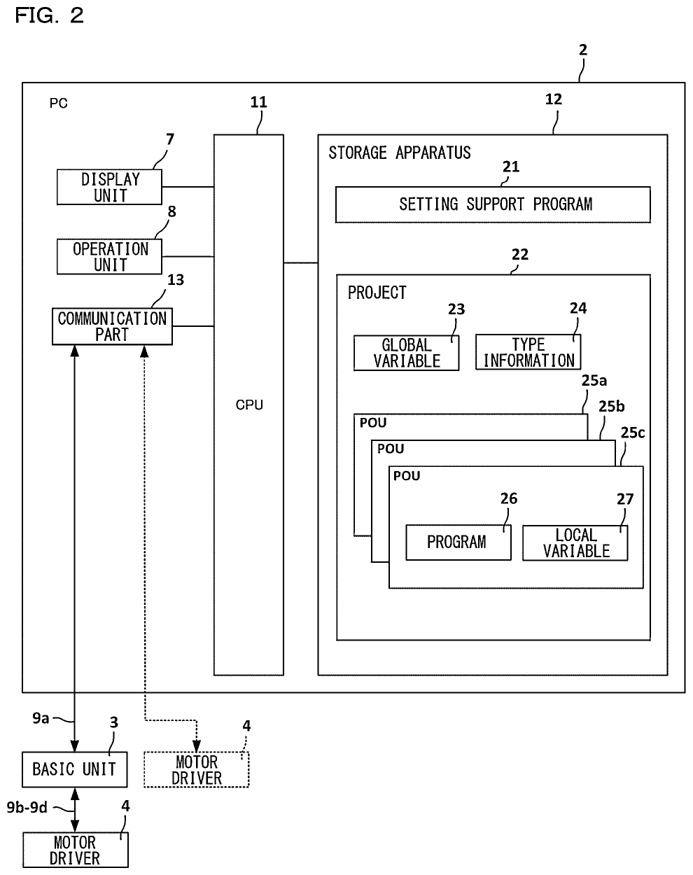

FIG. 2 is a block diagram illustrating an electrical configuration of the PC 2. As illustrated in FIG. 2, the PC 2 includes a CPU 11, the display unit 7, the operation unit 8, a storage apparatus 12, and a communication part 13. The display unit 7, the operation unit 8, the storage apparatus 12, and the communication part 13 are electrically connected to the CPU 11. The storage apparatus 12 includes a RAM, a ROM, an HDD, and an SSD, and may further include a detachable memory card. The CPU is an abbreviation for central processing unit. The ROM is an abbreviation for read-only memory. The RAM is an abbreviation for random access memory. The HDD is an abbreviation for hard disk drive. The SSD is an abbreviation of solid state drive.

A user of the PC 2 causes the CPU 11 to execute a setting support program 21 stored in the storage apparatus 12, edits a project 22 through the operation unit 8, and executes the setting of each of the motor drivers 4. The PC 2 may also be referred to as an engineering tool. The project 22 includes one or more user programs (POUs 25a to 25c), a global variable 23, type information 24 of the variable defined by the user, and the like. The POU is a generic term for a module, a function block, and a function. Further, the module is executed periodically or in response to a designated event. The function and the function block are each executed in response to a call. The POUs 25a to 25c are expressed as POUs 25 when matters common among the POUs 25a to 25c are described. The global variable 23 is a variable (variable group) that can be commonly accessed from the POUs 25a to 25c. Each of the POUs 25a to 25c has a program 26 such as a ladder program and a local variable 27. The local variable 27 is a variable (variable group) accessible only from the program 26 in the POU 25 to which the local variable belongs. For example, the local variable 27 of the POU 25c is accessible from the program 26 of the POU 25c but inaccessible from the program 26 of the POU 25a.

Editing the project 22 includes creation and a change (re-editing) of the project 22.

The user reads the project 22 stored in the storage apparatus 12 as necessary, and changes the project 22 using the setting support program 21. In this manner, the version of the project 22 is continuously updated. Basically, an old version of the project 22 is overwritten by a new version of the project 22.

The communication part 13 communicates with the basic unit 3 via a communication cable 9a. The CPU 11 transfers the project 22 to the basic unit 3 via the communication part 13. The communication part 13 includes a communication circuit capable of executing communication conforming to a USB standard, a communication circuit that performs wired LAN communication, a communication circuit that performs wireless LAN communication, and the like. The communication part 13 may communicate with the motor drivers 4 via a communication cable.

### (3) Basic Unit

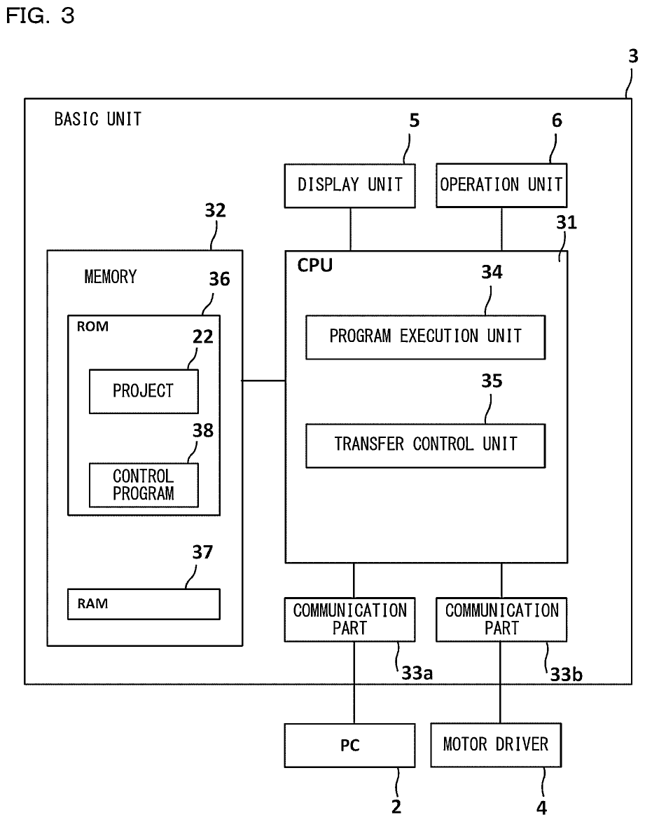

FIG. 3 illustrates a hardware configuration of the basic unit 3. The CPU 31 writes information in a memory 32 and reads information from the memory 32. The memory 32 may include an HDD or an SSD (not illustrated) and a detachable memory card in addition to a ROM 36 and a RAM 37. The ROM 36 may be any memory such as a flash memory or an EEPROM that can hold information even if electric power of the basic unit 3 is cut off. The ROM 36 includes a storage area that stores the project 22 created and transferred by the PC 2 and a storage area that stores a control program 38. The control program 38 is a program that controls execution of the user program, transfer of the user program, switching of the user program, and the like. The ROM 36 may store the first project 22 that is an old-version project and the second project 22 that is a new-version project, or may store only the second project 22. The RAM 37 may be referred to as a data memory. Furthermore, the CPU 31 receives an input of information from the operation unit 6. The CPU 31 displays various types of information on the display unit 5.

The CPU 31 is connected to the PC 2 via a communication part 33a, and is connected to the motor driver 4 via a communication part 33b to perform communication. Further, the communication part 33a is, for example, a communication circuit compatible with USB or Ethernet. The communication part 33b is a communication circuit capable of executing communication compatible with a protocol of Industrial Ethernet (for example, EtherCAT, EtherNet/IP, PROFINET, and MECHATROLINK-III). Further, the communication parts 33a and 33b can execute cyclic communication and message communication.

The CPU 31 includes a program execution unit 34 that executes the POU 25 included in the project 22, and a transfer control unit 35 that controls transfer of the project 22 from the PC 2.

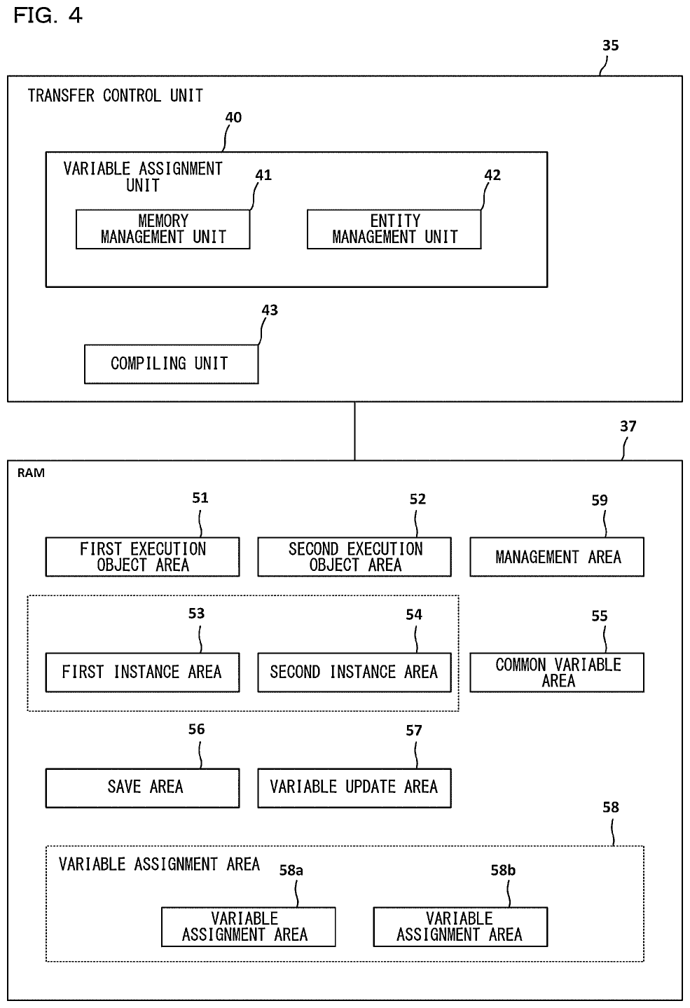

FIG. 4 illustrates details of the transfer control unit 35 and details of information developed in the RAM 37. The transfer control unit 35 includes a variable assignment unit 40 and a compiling unit 43. The variable assignment unit 40 further includes a memory management unit 41 and an entity management unit 42. The variable assignment unit 40 assigns an address of a storage area in the RAM 37 to each of the global variable 23 and the local variable 27 described in the project 22. The memory management unit 41 manages the assignment of the address to each of the global variable 23 and the local variable 27 to be stored in a common variable area 55. The common variable area 55 is referred to by both a new-version program and an old-version program. The entity management unit 42 assigns an address in a first instance area 53 secured in the RAM 37 to an instance of a function block (FB) or a function (FUN) instantiated by being called by a first execution object developed in a first execution object area 51. That is, each time a function block instance is defined in the POU 25, the function block instance is generated. The entity management unit 42 assigns an address in a second instance area 54 secured in the RAM 37 to an instance of a function block instantiated by a second execution object developed in a second execution object area 52. Note that the first execution object is, for example, an execution code generated by the compiling unit 43 compiling the POU 25 included in the old-version project 22. The second execution object is, for example, an execution code generated by the compiling unit 43 compiling the POU 25 included in the new-version project 22. In this manner, a new-version execution code and an old-version execution code are stored in the RAM 37, so that the execution code can be updated (switched) in a short time. For example, the compiling unit 43 can also store the new-version execution code in the second execution object area 52 while the old-version execution code is being executed by the program execution unit 34.

The RAM 37 may further include a management area 59, a common variable area 55, a save area 56, a variable update area 57, and a variable assignment area 58. The management area 59 is an area that stores information indicating which of a first execution code stored in the first execution object area 51 and a second execution code stored in the second execution object area 52 needs to be executed. The common variable area 55 is an area in which the global variable 23 and the local variable 27 used by the first execution code and the second execution code are stored. In the present embodiment, since the variables and the like are stored in the common variable area 55, which is a common storage area of the first execution code and the second execution code, it is necessary to maintain, reassign, or newly assign an address where the variables are stored for switching the execution code. For example, when there is a variable whose type has not been changed between the first project 22 and the second project 22, an address assigned to the variable is maintained. As a result, an execution code stop time accompanying the switching of the execution code is reduced. When the type is changed or a size of a storage area of the variable is enlarged or reduced, the address assigned to the variable is changed. Further, when a new variable is defined in the second project 22, an address is newly assigned to the variable. The save area 56 is an area for temporarily storing a value stored in a variable of the first project 22 when the value stored in the variable of the first project 22 is stored in a variable of the second project 22. The variable update area 57 stores information (variable change information) useful for determining which variable is to be maintained and which variable is to be changed when the first project 22 is updated to the second project 22. The variable assignment area 58 is an area that stores information indicating an address (for example, head address) of a storage area assigned to each variable.

The variable assignment area 58 may be divided into a first variable assignment area 58a and a second variable assignment area 58b. The first variable assignment area 58a stores information indicating an address of a storage area assigned to a variable corresponding to the first project. The second variable assignment area 58b stores information indicating an address of a storage area assigned to a variable corresponding to the second project.

Due to the presence of the plurality of variable assignment areas 58a and 58b, for example, the memory management unit 41 can assign an address to a variable corresponding to the new-version project while the old-version execution code is being executed by the program execution unit 34.

### (4) Method of Updating Program

In general, it is necessary to stop the old-version project 22 in order to switch to the new-version project 22 transferred from the PC 2 when the basic unit 3 is already executing the old-version project 22. When the project 22 is stopped, a line of a factory controlled by the basic unit 3 is stopped, and during that time, the factory cannot manufacture a product. Therefore, a stop time should be as short as possible. For example, a technique is conceivable in which a variable area that stores variables of the old-version project 22 and a variable area that stores variables of the new-version project 22 are separately secured in the RAM 37, and the variables are copied from one variable area to the other variable area during the stop time. However, among a large number of variables, the number of variables changed by an update of the project 22 is small. Thus, the stop time would be reduced if a variable that actually requires a change or assignment of an address or value writing is specified and only the variable is processed rather than copying all of the large number of variables. Therefore, the above-described common variable area 55 is adopted. Since the common variable area 55 can be accessed by both the first execution code and the second execution code in common, an address of a variable whose type or the like has not changed is maintained without any change when the execution code is switched. Further, a value stored in the variable is also maintained. As a result, time of work such as address assignment and value copying is greatly reduced.

### (4-1) Flowchart

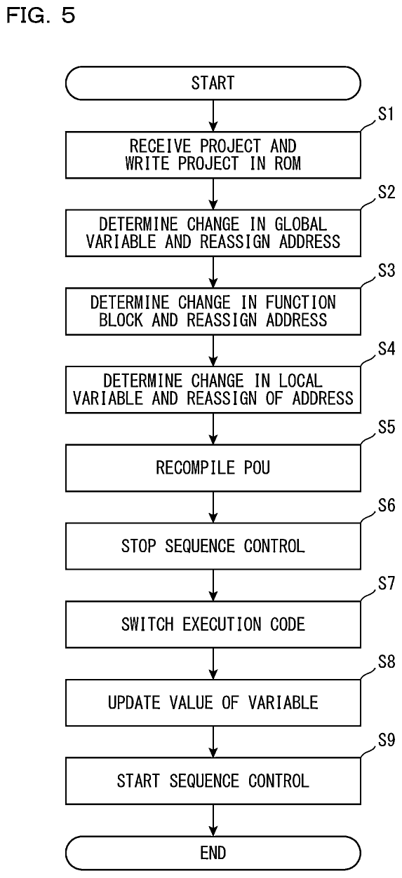

FIG. 5 illustrates a method of switching the old-version project 22 to the new-version project 22 during execution of the old-version of project 22.

In S1, the CPU 31 (the transfer control unit 35) communicates with the PC 2, receives the new-version project 22 from the PC 2, and writes the new-version project 22 in the ROM 36.

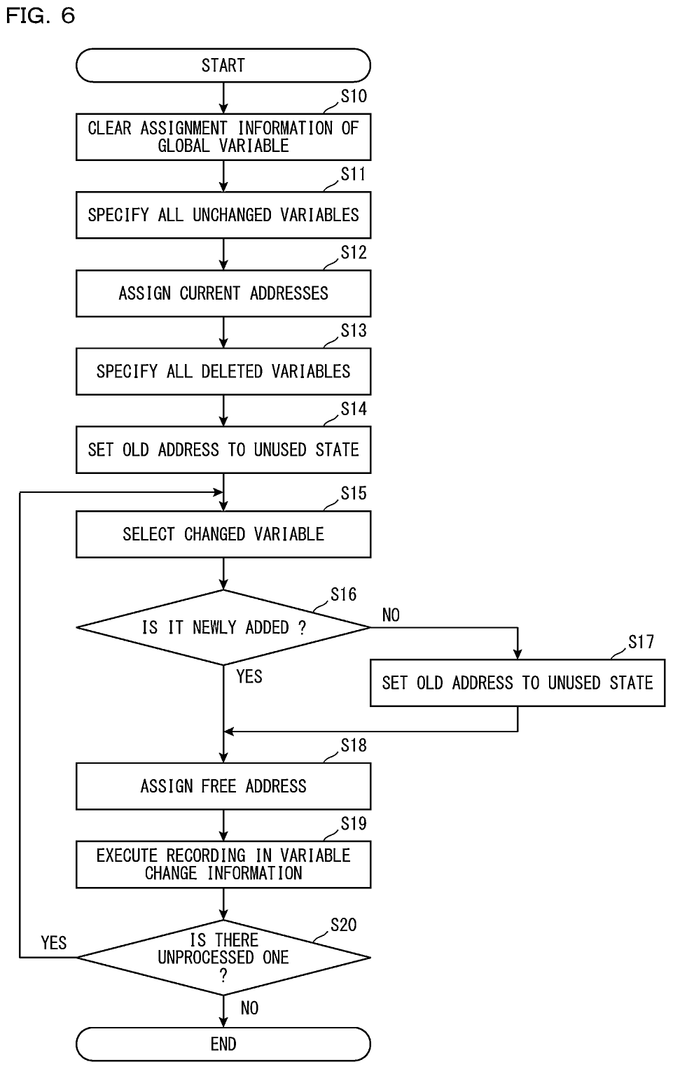

In S2, the CPU 31 (the variable assignment unit 40) determines a change in a type or the like for all of one or more global variables 23 included in the new-version project 22, and reassigns an address to the global variable 23 as necessary. Details of S2 will be described later with reference to FIG. 6.

In S3, the CPU 31 (the variable assignment unit 40) determines a change for all of one or more function blocks included in the new-version project 22 and reassigns an address as necessary.

In S4, the CPU 31 (the variable assignment unit 40) determines a change in a type or the like for all of one or more local variables 27 included in the new-version project 22, and reassigns an address to the local variable 27 as necessary. Details of S4 are similar to details of S2.

In S5, the CPU 31 (the compiling unit 43) recompiles all of one or more POUs 25 included in the new-version project 22. Note that the compiling unit 43 may recompile only the POU 25 edited by the user among all the POUs 25. Further, the compiling unit 43 may determine whether recompiling is necessary for all the POUs 25, and recompile only the POU for which recompiling is determined to be necessary.

In S6, the CPU 31 (the program execution unit 34) stops sequence control. That is, the program execution unit 34 stops the execution of the old-version project 22. Note that the CPU 31 prohibits an interrupt such that execution of an interrupt program is not newly started.

In S7, the CPU 31 switches the execution code. Specifically, the CPU 31 rewrites information indicating the execution code stored in the management area 59 (for example, a head address of a storage area in which the execution code is stored) from the old-version execution code to the new-version execution code. That is, the object area referred to by the program execution unit 34 is switched from the first execution object area 51 to the second execution object area 52.

In S8, the CPU 31 updates a value stored in a variable. For example, the CPU 31 updates the value of the variable based on variable update information stored in the variable update area 57. The variable update information includes, for example, a data type and an address before an update of a variable whose value needs to be updated, and a data type, an address, and an initial value after the update. Further, the variable update information may include information indicating whether to hold and initialize a value for each variable. When the value of the variable is to be held, the CPU 31 reads the value of the variable from an address before a change, performs implicit type conversion as necessary, and writes the value in an address after the change. When the value of the variable is to be initialized, the CPU 31 writes the initial value to the address after the change.

In S9, the CPU 31 (the program execution unit 34) starts the sequence control. That is, the program execution unit 34 executes the new-version execution code stored in the second execution object area 52.

### (4-2) Details of Change Processing Related to Global Variable

FIG. 6 illustrates S2 (the determination of the change in the type or the like for all the global variables 23, and the address reassignment with respect to the global variable 23 as necessary) in detail.

In S10, the CPU 31 clears assignment information stored in the variable assignment area 58 for all the global variables 23.

In S11, the CPU 31 compares the old-version project 22 with the new-version project 22, and specifies all variables having no change in the type and the like. That is, all the variables for which assigned addresses do not need to be changed are specified.

In S12, the CPU 31 assigns a current address in the common variable area 55 to each of the variables specified in S11. That is, the address already assigned in the common variable area 55 is maintained.

In S13, the CPU 31 compares the old-version project 22 with the new-version project 22, and specifies all deleted variables. The variables that exist in the old-version project 22 but do not exist in the new-version project 22 are specified. That is, the variables for which the assigned addresses need to be changed to an unused state are specified. Alternatively, addresses to be changed from a used state to the unused state are specified.

In S14, the CPU 31 changes old addresses used by the variables deleted in the common variable area 55 to the unused state (free state).

In S15, the CPU 31 compares the old-version project 22 with the new-version project 22, specifies all changed variables, and selects one of the variables.

In S16, the CPU 31 determines whether the selected variable is a newly added variable. Here, the newly added variable is a variable that does not exist in the old-version project 22 but exists in the new-version project 22. A variable that is present in both the versions but has a changed type or the like is determined not to be the newly added variable. When the selected variable is the newly added variable, the CPU 31 proceeds from S16 to S18. On the other hand, when the selected variable is the variable that is present in both the versions but has a changed type or the like, the CPU 31 proceeds from S16 to S17.

In S17, the CPU 31 changes an old address assigned to the selected variable from the used state to the unused state (free state). Thereafter, the CPU 31 proceeds from S17 to S18.

In S18, the CPU 31 assigns the variable selected in S15 to an address in the free state in the common variable area 55.

In S19, regarding the variable selected in S15, the CPU 31 records a data type and the address of the variable before the change, and a data type, the address, and an initial value of the variable after the change in the variable update information held in the variable update area 57.

In S20, the CPU 31 determines whether there is a variable for which address assignment processing has not been completed among the changed variables. When there is a variable for which the address assignment processing has not been completed, the CPU 31 returns from S20 to S15 and selects the next variable. Thereafter, the CPU 31 repeats S16 to S20. On the other hand, when there is no variable for which the address assignment processing has not been completed, the CPU 31 proceeds from S20 to S3 illustrated in FIG. 5.

### (4-3) Determination of Change in Function Block Call and Reassignment

Here, details of S3 will be described. The CPU 31 compares the old-version project 22 with the new-version project 22, and determines whether there is a change regarding a call of a function block. The call of the function block may be defined as an instance (memory area). In the new-version project 22, the CPU 31 newly assigns a memory area to the instance of the function block to which the call of the function block has been newly added or whose consumed memory size has changed. The CPU 31 changes a memory area assigned to a deleted function block instance to an unused state. Regarding a function block whose address has been changed, the CPU 31 records information of a variable included in an instance before the change in the variable change information.

### (4-4) Determination of Change in Local Variable and Reassignment

Details of processing according to S4 are basically common to processing related to the global variable 23. The CPU 31 compares the old-version project 22 with the new-version project 22, and determines whether there is a change regarding the local variable 27. When any of the local variables 27 has changed, the CPU 31 assigns the same address as before the change to the local variable 27 that has not been changed. The CPU 31 assigns the local variable 27 that has changed to a free address. The procedure of reassignment is as follows.

(i) Assignment of unchanged local variable 27. An address is assigned to the unchanged local variable 27 without changing an address offset from a head of a function block.

(ii) Assignment of changed local variable 27. The changed local variable 27 is assigned to a free area. Processing content related to the variable added here may be added to an update list at the time of online transfer of the project 22 from the PC 2 to the basic unit 3. For example, the added variable is initialized with an initial value. The changed variable holds a value before the change in response to the change. Information (an address, a data type, and the initial value) of the changed variable is recorded in the variable change information. In this manner, the flowchart of the determination of a change in the local variable 27 and the reassignment is equivalent to one obtained by replacing the global variable 23 with the local variable 27 in the description of the flowchart illustrated in FIG. 6. Note that the address is determined according to an offset in a storage area to which the local variable 27 is assignable.

### (4-5) Recompiling of POU

Here, details of processing according to S5 will be described. The compiling unit 43 compiles the POU 25 of the new-version project 22, and creates a new code (object) for execution in the second execution object area 52. Both the first execution object area 51 and the second execution object area 52 exist in the RAM 37, and the program execution unit 34 refers to one of both indicated by information stored in the management area 59 and executes the execution code stored therein. When the management area 59 refers to the first execution object area 51, the compiling unit 43 creates a new execution object in the second execution object area 52 that is not referred to by the management area 59.

The CPU 31 determines whether there is a change in the POU 25 (program module (PROGRAM), function block (FB), or function (FUN)). The CPU 31 determines that there is a change in the POU 25 when any of the following applies.
A program has been edited.
The local variable 27 has been edited.
The global variable 23 related to the POU has been edited.
A structure related to the POU has been edited.
A function or a function block related to the POU has been edited.

The expression that “the function or the function block related to the POU has been edited” indicates a case where, for example, a type of an argument of the function or function block has been changed or a type of a structure used in the argument has been changed.

When there is a change in the POU 25, the compiling unit 43 recompiles the POU 25. When there is no change in the POU, the compiling unit 43 copies an object being executed and held in the first execution object area 51 to the second execution object area 52 without any change.

The variable assignment and the program compiling are executed separately. Therefore, in step S5, the compiling unit 43 may compile all the programs regardless of presence or absence of a change. As an example, according to the present embodiment, the compiling unit 43 executes compiling only for a program having a difference, and only copies the execution code for a program having no difference. As a result, a compiling time is shortened. Therefore, the execution code is a relocatable code.

Here, S4 is executed for all the POUs 25, and then S5 is executed collectively for all the POUs 25, but this is merely an example. For example, S4 and S5 may be executed by selecting one POU 25 as a processing target from among the plurality of POUs 25, and then, S4 and S5 may be executed by selecting another POU 25 as a processing target.

Note that S2 to S5 are executed while the old-version project 22 is being executed. As a result, the stop time accompanying the switching of the project 22 is reduced.

### (4-6) Details of Variable Change

The CPU 31 may determine whether a variable has been changed based on a name (variable name) given to the variable. For example, when a certain variable has the same name and the same variable type between the old-version project 22 and the new-version project 22, the CPU 31 holds a value stored in the variable without any change. There may be a variable whose name is the same but whose type has changed. In this case, the CPU 31 holds a value stored in the variable if the value can be followed by applying implicit type conversion or the like between a type before the change and a type after the change. When the following is impossible, the CPU 31 initializes the variable with an initial value.

When the initial value is not designated, the CPU 31 substitutes a value determined in advance for the corresponding type as the initial value of the variable.

When the data type has been changed, the CPU 31 performs implicit type conversion in consideration of the data type before the change and the data type after the change to follow the type change.

(i) In a case where the type before the change is an integer type and the type after the change is also an integer type, the CPU 31 performs implicit type conversion. When the changed type cannot express the original value, the CPU 31 may saturate the value of the variable to an upper limit or a lower limit.

(ii) In a case where the type before the change is an integer type and the type after the change is a floating point type, the CPU 31 performs implicit type conversion. When the changed type cannot express the original value, the CPU 31 saturates the value of the variable to the upper limit or the lower limit.

(iii) There is a case where a maximum length of a character string is changed. For example, when a maximum length of the type after the change is shorter than a maximum length of the type before the change, the character string stored in the variable of the type before the change cannot be stored in the variable of the type after the change. In this case, the CPU 31 may truncate the character string so as to fit in the maximum length of the type after the change.

(iv) There is a case where a data type of the character string is changed (such as a change from STRING to WSTRING). For example, the STRING type may be ASCII or a multi-byte character string (such as ShiftJIS). The WSTRING type may be a unicode character string (utf-16). In this case, the CPU 31 converts a character code so as to store the character string. When the character string stored in the variable of the data type before the change cannot be expressed by the data type after the change, the CPU 31 may replace the character string with a specific character.

(v) In a case where both the types are a BOOL type and an integer type, the CPU 31 performs implicit type conversion. Specifically, TRUE is converted to 1, and FALSE is converted to 0.

(vi) In a case where both the types are an enumeration type and an integer type, the CPU 31 performs implicit type conversion.

(vii) There is a case where the number of elements and the number of dimensions of an array is changed. In this case, the CPU 31 holds a value of a corresponding element number that pre-exists before the change.

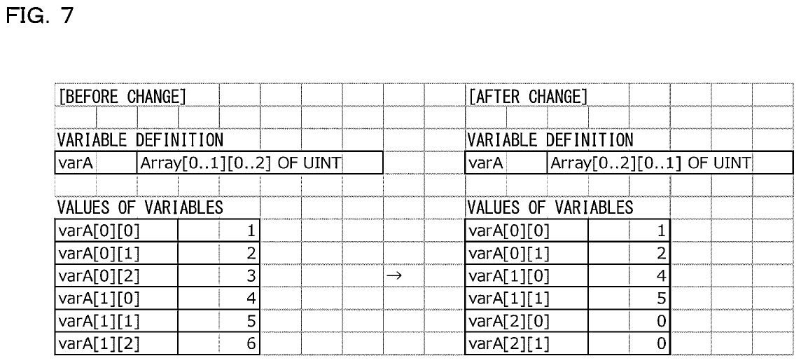

FIG. 7 illustrates an example of the change of the array. In this example, a variable varA is a variable of an array type.

The number of dimensions of the variable varA is two. In this example, a possible range of element numbers has been changed from [0 . . . 1] [0 . . . 2] to [0 . . . 2] [0 . . . 1]. According to FIG. 7, varA [0] [0], varA [0] [1], varA [1] [0], and varA [1] [1] exist before and after the change. Thus, values stored in the variables before the change are taken over by the variables after the change. On the other hand, varA [0] [2] and varA [1] [2] exist among variables before the change, but these cannot exist according to a variable definition after the change. Thus, varA [0] [2] and varA [1] [2] are deleted together with their values. Further, varA [2] [0] and varA [2] [1] are added according to the variable definition after the change. Thus, a predetermined initial value (for example, 0) is stored in each of varA [2] [0] and varA [2] [1]. The predetermined initial value may be designated by the user in advance.

(viii) There is a case where a structure type is changed. If there are member names corresponding to each other between a structure before the change and a structure after the change, the above-described change processing of (i) to (vii) is executed between the members.

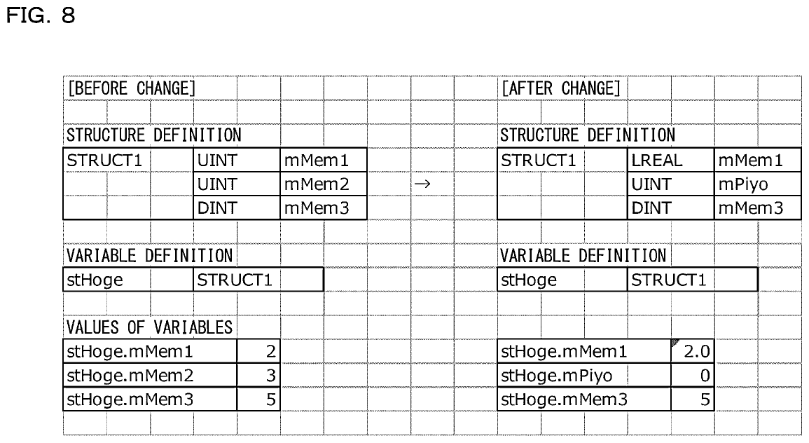

FIG. 8 illustrates an example of the change of the structure type. A structure STRUCT1 before the change has member variables mMem1 and mMem2 of an unsigned integer type with a length of one word and a member variable mMem3 of a signed integer type with a length of two words as member variables. As a variable of this structure type, “stHoge” is defined. In “stHoge.mMem1”, 2 is stored. In “stHoge.mMem2”, 3 is stored. In “stHoge.mMem3”, 2 is stored.

As illustrated in FIG. 8, the definition of the structure is changed. In this example, a name of “mMem2”, which is the member variable of a UINT type, has been changed to “mPiyo”. Thus, “stHoge.mPiyo”, which is a member variable in “stHogeb” after the change, is initialized with an initial value. A type of the member variable mMem1 has been changed from the UINT type to an LREAL type (double-precision floating point type). Therefore, implicit type conversion is applied, and a value of a member variable stHoge.mMem1 is type-converted from 2 to 2.0.

(ix) There is a case where a function block instance is added. That is, there is a case where a function block call is added in the POU 25. In this case, the CPU 31 initializes all of variables included in the added function block instance with an initial value. The function block instance includes an input variable (IN), an output variable (OUT), and a local variable.

### (4-7) Details of Function Block

In general, a function block includes a code (program) and data. The program of each function block may be referred to as a “definition”. The data may be referred to as an “instance”. The same program can be applied to a plurality of pieces of data due to a relationship between the definition and the instance.

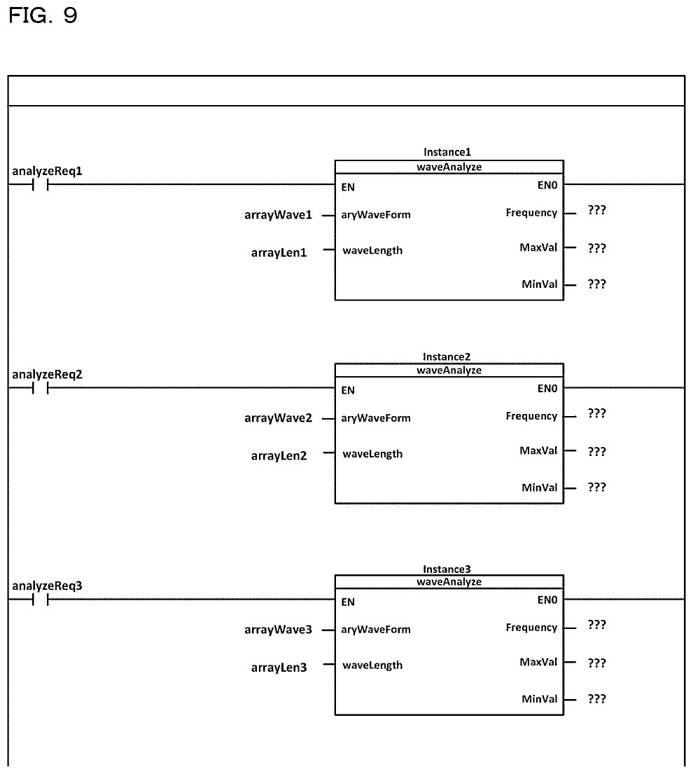

FIG. 9 suggests generating three different instances for the same function block definition in the POU 25. A call of the function block is performed by designating an instance. Note that the same instance may be called a plurality of times. A name of the function block is “waveAnalyze”. In this function block, “aryWaveForm” which is an array type holding waveform data and “waveLength” which is a variable indicating a waveform length are defined as the input variables. As the output variable, there are “Frequency” which is a variable for outputting a frequency of the waveform data, “Maxval” for outputting a maximum value of amplitude of the waveform, and “Minval” for outputting a minimum value of the amplitude of the waveform.

In the first call, waveform data stored in a variable “arrayWave1” is input to “aryWaveForm” of “intance1”, and a value stored in a variable “arrayLen1” of “intance1” is output to “waveLength”. The input variable and the output variable can also be omitted. When the input variable is omitted, an instance variable holds a value.

In the second call, waveform data stored in a variable “arrayWave2” is input to “aryWaveForm” of “intance2”, and a value stored in a variable “arrayLen2” of “intance2” is output to “waveLength”.

In the third call, waveform data stored in a variable “arrayWave3” is input to “aryWaveForm” of “intance3”, and a value stored in the variable “arrayLen3” of “intance3” is output to “waveLength”.

As described above, the function block is used by generating the instance. The instance is an entity of a memory and may be understood to be the same as an entity of a structure of a data type “function block”. There may be a global function block and a local function block in instances of function blocks. The local function block is defined as the local variable 27. The instance may also be defined as the local variable 27 in the function block. The instances of the function blocks are nested via the local variable 27.

### (4-8) Details of Function Block

There is a case where there is an addition, a change, or a deletion in a program module (PROGRAM) or a function block instance. In this case, assignment of a storage area of the related local variable 27 is required.

The CPU 31 assigns a storage area of the global variable 23 and a storage area of the local variable 27 of the program module or the function block to successive storage areas, respectively. When there is an addition, a deletion, or a change in the module or the function block instance (the number of used variables has changed), the CPU 31 secures a new successive storage area in a free storage area. When an instance is deleted or changed, a storage area that has been used by the instance is changed to the unused state. For an added or changed instance, a successive storage area is secured in an unused storage area and the instance is assigned thereto. As a result, an address assigned to an unchanged variable of the module or the function block can be maintained.

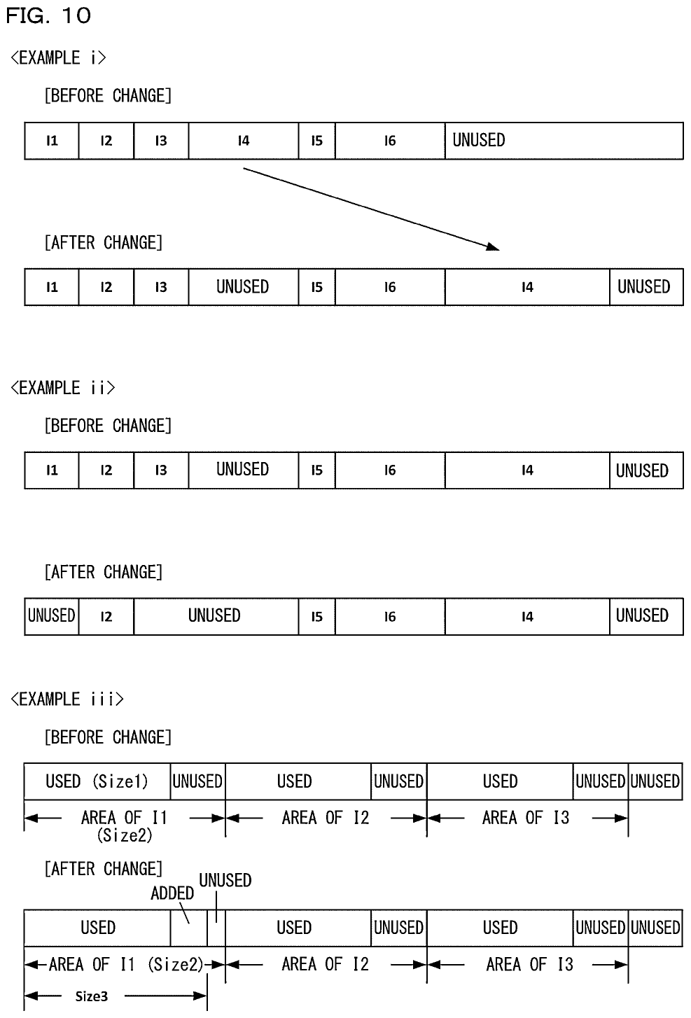

FIG. 10 illustrates two examples i and ii regarding a storage area secured in the RAM 37. In the example i, before a change, six instances I1 to 16 of the function block are successively stored in storage areas. In FIG. 10, “UNUSED” represents a storage area in a free state. After the change, a size of the instance I4 has increased. Therefore, a storage area of the instance I4 is secured in a free area.

In the example ii, before a change, six instances I1 to 16 of the function block are successively stored in storage areas. After the change, the instances I1 and 13 are deleted. Therefore, storage areas of the instances I1 and 13 are changed to the unused state.

Although the function block instance is described here, a storage area of the program module or the global variable 23 is also handled in a similar manner.

It may be greatly wasteful to assign a storage area to an unused area every time the number of used variables in the program module or the function block is changed. Specifically, even with a small change, all values of the local variables 27 of the module or the function block need to be moved at the time of online transfer of the project 22. As a result, a stop time of the program at the time of online transfer increases.

Therefore, an extra unused storage area may be assigned to the global variable 23, the module, the function block, and the instance. That is, a storage area having a size larger than a size required for storing these is assigned to these.

For example, as illustrated in an example iii of FIG. 10, a size required to store a function block instance I1 before a change is Size1, but in practice, a storage area of Size2 larger than Size1 is assigned. It is assumed that, after the change, the number of variables used in the function block increases, a size required to store the instance is Size3, and Size3 is smaller than Size2. In this case, the CPU 31 does not change the storage area assigned to the instance. This makes it possible to reduce the stop time.

Note that there is a case where the size of the instance I1 is reduced to Size4 smaller than Size1 that is the original size. Also in this case, the CPU 31 may maintain the storage area of Size2 assigned to the instance I1 without any change. This reduces the stop time.

Also, in the case of the example iii, an unused area described at the right end is required. This is because, when a new module or function block is added, an instance thereof needs to be secured in the unused area at the right end. Further, it is also assumed that storage areas become insufficient as variables are added in the individual storage areas, and it becomes difficult to newly add a variable or change the variables. In this case, the CPU 31 may move the storage areas of the POU 25 to a whole unused area. Alternatively, the CPU 31 may display an error notification with respect to the user on the display unit 5 or the display unit 7 and causes the online transfer of the project 22 to fail.

The whole unused area and an unused area (extra area) of each module or function block instance are reserved in the RAM 37 by the CPU 31. Sizes of these may be designated by the user in advance.

### (4-9) Details of Function Block

One or more variables are present in a program module (PROGRAM) or a function block instance. Assignment of addresses to these individual variables is described hereinafter.

In order to shorten the stop time of the program execution at the time of the online transfer, an assignment method in the example iii may be adopted to assign a storage area to an instance. When a variable is added, deleted, or changed in the online transfer, the variable is assigned as follows.

(i) An added variable is newly assigned to an unused storage area.

(ii) A storage area assigned to a deleted variable is changed to “unused”.

(iii) For a changed variable, an originally assigned storage area is changed to “unused”, and the changed variable is assigned to a storage area newly secured in an unused area. That is, the change is processed as a combination of the deletion and the addition. As a result, an address of a variable whose type or the like has not been changed is maintained without any change.

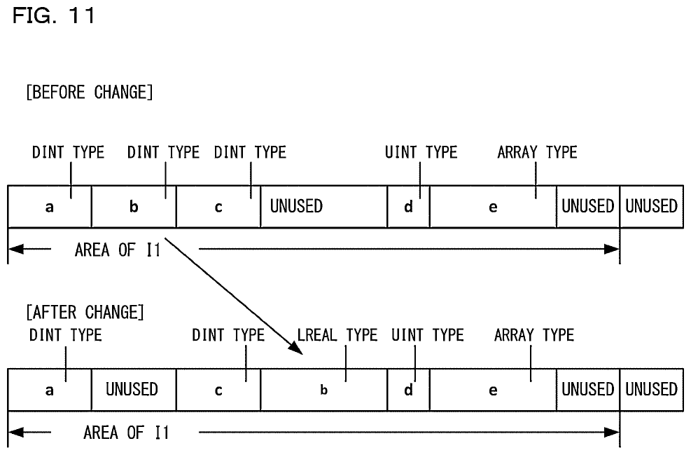

FIG. 11 illustrates a storage area of a function block instance I1 including variables a to e. Before a change, a type of the variables a, b, and c is a DINT type. A type of the variable d is the UINT type. A type of the variable e is the array type (for example, ARRAY [0 . . . 3]).

In this example, the type of the variable b has been changed from the DINT type to the LREAL type, the variable b of the LREAL type cannot be stored in the original storage area in which the variable b of the DINT type has been stored. Therefore, a storage area for the variable b of the LREAL type is assigned to an extra unused area that has been secured. In this case, in variable update information for the variable b, there is no description regarding an address, a data type, and an initial value, and “implicit type conversion” is described regarding an initialization method.

### (4-10) Management of Module and Function Block Instance

A call of a function block is performed by designating an instance from a function block call command. In order to call the function block, the following two pieces of information regarding the function block are required on a calling side.

(A) Address of function block execution code (object)

(B) Address of local variable of function block instance

The address of A is linked with a definition of the function block. When a certain program is changed by the online transfer, the address of A changes. This is not limited to a change in the function block, and may occur along with a change in another function block. Further, the definition and the call of the function block may be added.

The address of B is linked with a function block instance. When the function block instance is added by the online transfer, the address of B is added. When a new storage area is required due to a change in the number of local variables 27 used in the function block by the online transfer, an address of a work area also changes.

Instance information and an instance ID are used such that recompiling of a program of a caller is unnecessary even when the address of A and the address of B have changed due to the online transfer. The instance information is information that links and holds the instance ID, an address of an object, and an address of the local variable 27. The instance ID is identification information of an entity of the function block.

The program (POU 25) or the function block of the caller embeds, in an execution code (object code), an instance ID of a function block to be called and refers to instance information with the instance ID as an index at the time of execution. As a result, the address of the object and the address of the local variable 27 are acquired. An example of the instance information is as follows.

| Instance ID | Address of Object | Address of Local Variable |
|---|---|---|
| 1 | 0x80003020 | 0xC0000570 |
| 2 | 0x80003020 | 0xC000A200 |
| 3 | 0x80003020 | 0xC000CAF0 |
| 4 | 0x80003B00 | 0xC0007200 |
| . | . | . |
| . | . | . |
| . | . | . |

In this example, function blocks of the instance IDs 1, 2, and 3 have the same definition. That is, addresses of objects of the instance IDs 1, 2, and 3 are common, and execution programs are common.

At the time of the online transfer of the project 22, the address of the object and the address of the local variable 27 change. Therefore, it is necessary to update the instance information along with a change in the program. However, a storage area to be referred to may be switched by preparing instance information after the change in advance. As a result, a stop time of the sequence control may be shortened.

An instance ID is an integer value assigned in association with an instance of a function block. The instance ID does not change while the online transfer is continued for one associated instance. When the instance is deleted, the CPU 31 changes the instance ID to an unused state.

Note that an instance ID is used as an identification ID for managing an address including PROGRAM (module) and a function in the present embodiment. However, this is merely an example. The instance ID may be used only for a function block. Note that the instance ID is obtained by analyzing a call.

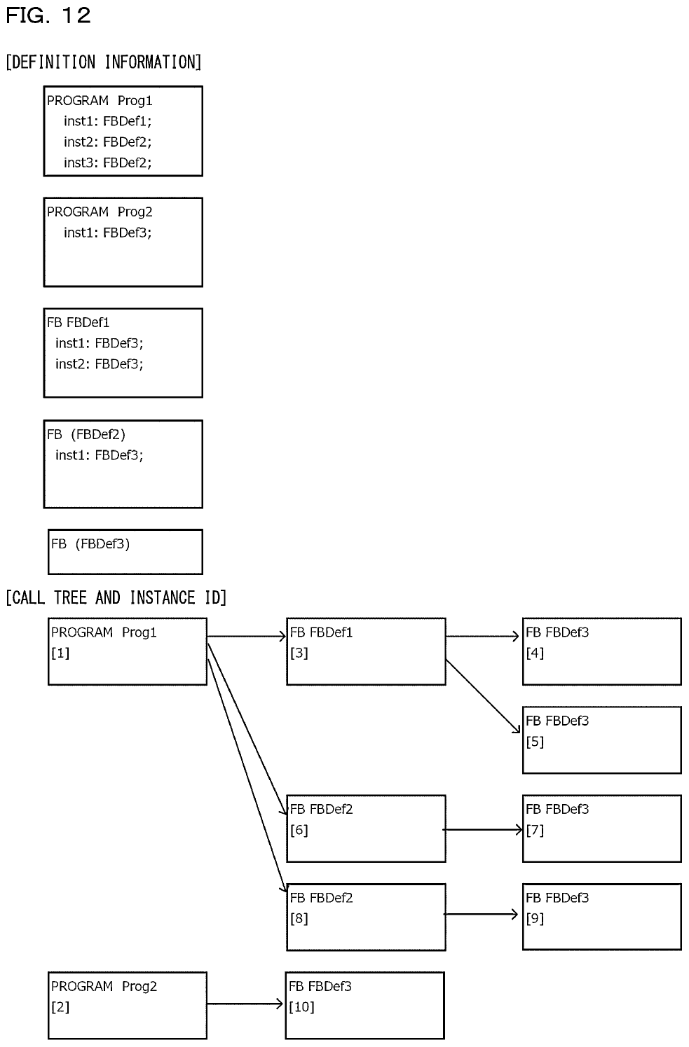

FIG. 12 illustrates definition information, a call tree, and instance IDs. In this example, two programs Prog1 and Prog2 and three function blocks FBDef1, FBDef2, and FBDef3 are defined.

The program Prog1 calls FBDef1 and FBDef2. FBDef1 is called once, and an instance inst1 is generated. FBDef2 is called twice, and an instance inst2 and an instance inst3 are generated.

The program Prog2 calls FBDef3. FBDef3 is called once, and an instance inst1 is generated.

FBDef1 calls FBDef3 twice. As a result, an instance inst1 and an instance inst2 are generated.

FBDef2 calls FBDef3 once. As a result, an instance inst1 is generated.

The call tree and the instance IDs are illustrated in the lower part of FIG. 12. An instance ID of 1 is given to the program Prog1. An instance ID of 2 is given to the program Prog2.

An instance ID of 3 is given to the function block FBDef1 called from the program Prog1. Instance IDs of 4 and 5 are given to the function blocks FBDef3, respectively, called twice from the function block FBDef1. Instance IDs of 6 and 8 are given to the function blocks FBDef2, respectively, called twice from the program Prog1. An instance ID of 7 is given to the function block FBDef3 that is further called from the function block FBDef2 that is called first. An instance ID of 9 is given to the function block FBDef3 that is further called from the function block FBDef2 called second.

An instance ID of 10 is given to the function block FBDef3 called from the program Prog2.

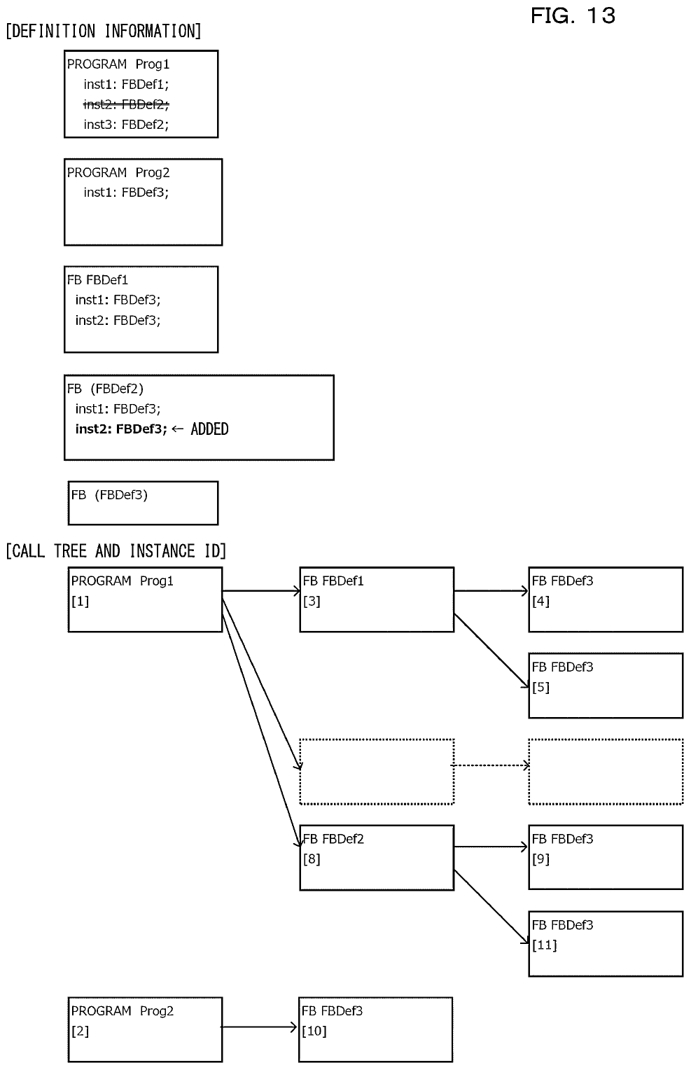

FIG. 13 illustrates that the new-version project 22 has been created by deleting inst2 of the program Prog1 in the old-version project 22 illustrated in FIG. 12. Furthermore, inst2 (FBDef3) is added to FBDef2.

When a module is added or deleted or a definition of an instance of a function block is changed, the CPU 31 reconstructs a call (instance) tree and changes an instance ID of a deleted instance to the unused state. Furthermore, the CPU 31 assigns an instance ID to an added instance.

As illustrated in FIG. 13, since inst2 of Prog1 is deleted, the instance of FBDef2 with the instance ID=6 and the instance of FBDef3 with the instance ID=7 are deleted in the call tree.

From the instance of FBDef2 with the instance ID=8, FBDef3 is called twice as a definition of FBDef2 is changed. Here, since the first call of FBDef3 pre-exists before the change, the instance ID of 9 is maintained without any change for the first call of FBDef3. Since the second call of FBDef3 has been added, an instance ID of 11 is given to the second call of FBDef3.

In this manner, the instance IDs do not change in the function blocks having no change in calling relationship. As a result, when there is no change in the function block to be called, the instance ID does not change, and recompiling is also unnecessary.

In the present embodiment, an instance ID is an index of instance information which is an array. Therefore, an instance ID in the unused state may be reused. For example, for the second call of FBDef3, 6 or 7 may be reused as the instance ID.

### (4-11) Update of Value

### (4-11-1) Saving of Value

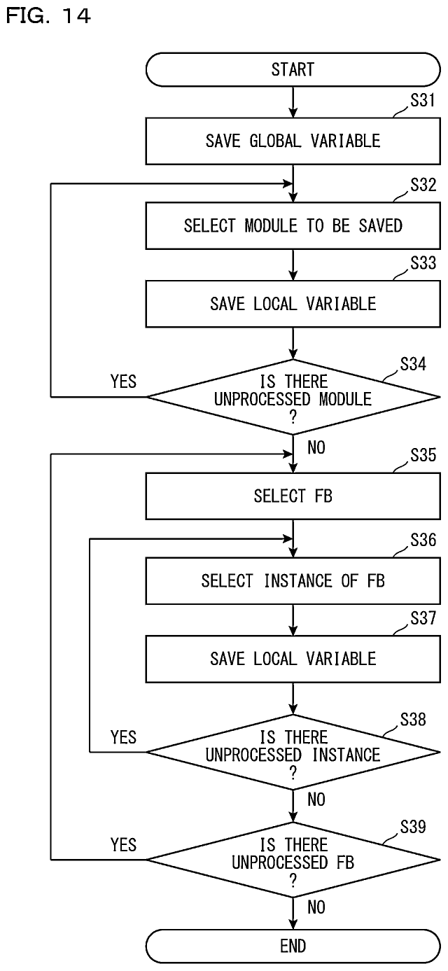

FIG. 14 illustrates a method of saving a value stored in a variable used in the old-version project 22 in update processing of S8. The value is saved and restored while the sequence control is stopped.

In S31, the CPU 31 saves, in the save area 56, a value stored in the global variable 23.

S32 to S34 are processes related to a module of the POU 25. Hereinafter, the module is sometimes referred to as the module 25 for convenience.

In S32, the CPU 31 selects the module 25 to which saving processing is not yet applied from among all the modules 25 included in the old-version project 22.

In S33, the CPU 31 saves all values stored in the local variables 27 for the selected module 25 in the save area 56.

In S34, the CPU 31 determines whether the module 25 that has not been subjected to the saving processing remains. In a case where there remains the module 25 that has not been subjected to the saving processing, the CPU 31 returns from S34 to S32, and selects the next module 25. Thereafter, the CPU 31 repeats S32 to S34. In a case where there is no module 25 that has not been subjected to the saving processing, the CPU 31 proceeds from S34 to S35.

Steps S35 to S39 are processes related to a function block of the POU.

In S35, the CPU 31 selects a function block that has not been subjected to the saving processing among all function blocks defined in the old-version project 22.

In S36, the CPU 31 selects an instance that has not been subjected to the saving processing from among all instances generated from the selected function block.

In S37, the CPU 31 saves, in the save area 56, values of all the local variables 27 linked with the instance that has not been subjected to the saving processing.

In S38, the CPU 31 determines whether an instance that has not been subjected to the saving processing remains. In a case where there remains an instance that has not been subjected to the saving processing, the CPU 31 returns from S38 to S36 and selects the next instance. Thereafter, the CPU 31 repeats S36 to S38. In a case where there remains no instance that has not been subjected to the saving processing, the CPU 31 proceeds from S38 to S39.

In S39, the CPU 31 determines whether a function block that has not been subjected to the saving processing remains in the old-version project 22. In a case where there remains a function block that has not been subjected to the saving processing, the CPU 31 returns from S39 to S35 and selects the next function block. Thereafter, the CPU 31 repeats S35 to S39. In a case where there remains no function block that has not been subjected to the saving processing, the CPU 31 ends the saving processing.

### (4-11-2) Restoration of Value

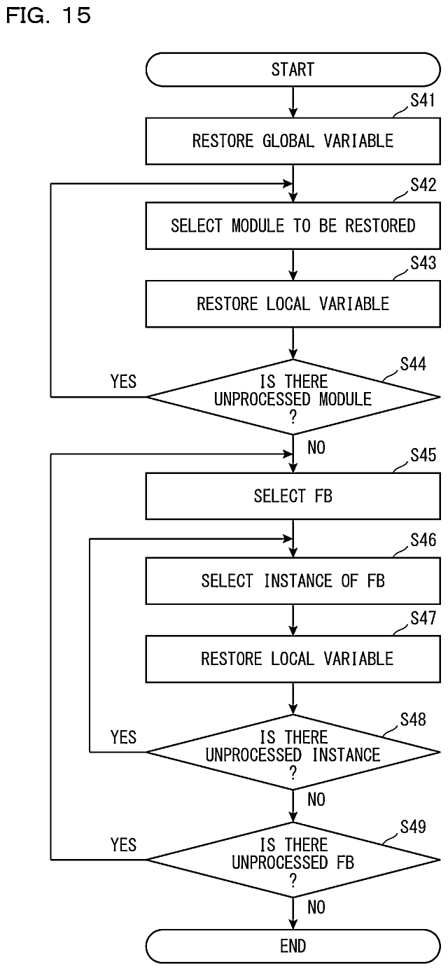

FIG. 15 illustrates a method of restoring a value from the save area 56 to a variable to be used in the new-version project 22 in the update processing of S8. In a case where an address assigned to a variable in the old-version project 22 coincides with an address to be assigned to the variable in the new-version project 22, it is not necessary to restore the value. In a case where the address assigned to the variable in the old-version project 22 does not coincide with the address to be assigned to the variable in the new-version project 22, the value is restored.

In S41, the CPU 31 restores the value stored in the save area 56 to the global variable 23.

S42 to S44 are processes related to a module.

In S42, the CPU 31 selects the module 25 to which restoration processing is not yet applied from among all the modules 25 included in the new-version project 22. Note that an initial value is stored for the added module 25.

In S43, the CPU 31 restores values from the save area 56 to all the local variables 27 for the selected module 25.

In S44, the CPU 31 determines whether the module 25 that has not been subjected to the restoration processing remains. In a case where there remains the module 25 that has not been subjected to the restoration processing, the CPU 31 returns from S44 to S42, and selects the next module 25. Thereafter, the CPU 31 repeats S42 to S44. In a case where there is no module 25 that has not been subjected to the restoration processing, the CPU 31 proceeds from S44 to S45.

Steps S45 to S49 are processes related to a function block.

In S45, the CPU 31 selects a function block that has not been subjected to the restoration processing among all function blocks defined in the new-version project 22. Note that an initial value is stored for a function block newly added in the new-version project 22.

In S46, the CPU 31 selects an instance that has not been subjected to the restoration processing from among all instances generated from the selected function block.

In S47, the CPU 31 restores values of all the local variables 27 linked with the instance that has not been subjected to the restoration processing from the save area 56.

In S48, the CPU 31 determines whether an instance that has not been subjected to the restoration processing remains. In a case where there remains an instance that has not been subjected to the restoration processing, the CPU 31 returns from S48 to S46 and selects the next instance. Thereafter, the CPU 31 repeats S46 to S48. In a case where there remains no instance that has not been subjected to the restoration processing, the CPU 31 proceeds from S48 to S49.

In S49, the CPU 31 determines whether a function block that has not been subjected to the restoration processing remains in the new-version project 22. In a case where there remains a function block that has not been subjected to the restoration processing, the CPU 31 returns from S49 to S45 and selects the next function block. Thereafter, the CPU 31 repeats S45 to S49. In a case where there remains no function block that has not been subjected to the restoration processing, the CPU 31 ends the restoration processing.

Note that, in a case where the common variable area 55 has a sufficient memory size, an edited or added variable may be assigned to an unused address in advance. For example, a value of the edited variable may be moved from a storage area before the change to a storage area after the change.

(5) Technical Ideas Derived from Embodiment

### [Viewpoint 1]

For example, there is a case where a CPU 31 (memory management unit 41) receives an instruction to switch to a second user program, which is an updated version of a first user program when a program execution unit 34 executes the first user program. In this case, a memory management unit 41 may create variable information for identifying a variable to be maintained and a variable to be changed by an update from the first user program to the second user program, and store the variable information in a RAM 37 (for example, variable update area 57). Based on the variable information, the memory management unit 41 may maintain an address in the RAM 37 in which a value of the variable to be maintained is stored, and may stop a logic operation by the program execution unit 34 and execute, at a break of the logic operation, address assignment in the RAM 37 in which a value of the variable to be changed is stored. Here, the logic operation means, for example, execution of the first user program (for example, ladder program) by the program execution unit 34.

The RAM 37 may further include a program memory (for example, first execution object area 51, second execution object area 52) that stores the user programs. The program memory may include a first execution object area 51 that stores the first user program (execution code (object code) generated by compiling old-version POU 25 by compiling unit 43) and a second execution object area 52 that stores the second user program (execution code (object code) generated by compiling new-version POU 25 by compiling unit 43). The RAM 37 may further include a third storage area (management area 59) that stores information indicating either the first user program stored in the first execution object area 51 or the second user program stored in the second execution object area 52 to be executed. In the RAM 37, a variable storage area (for example, first instance area 53, second instance area 54, common variable area 55) that stores the values of the variables may be a storage area shared by the first user program and the second user program. Here, a first instance area 53 stores an instance generated by calling a function block with an execution code stored in the first execution object area 51. A second instance area 54 stores an instance generated by calling a function block with an execution code stored in the second execution object area 52. A common variable area 55 stores a variable (for example, global variable 23, local variable 27) to be used by the execution code stored in the first execution object area 51 and a variable (for example, global variable 23, local variable 27) to be used by the execution code stored in the second execution object area 52. This makes it possible to efficiently switch the user program while operating a PLC.

### [Viewpoint 2]

The memory management unit 41 maintains an address in the variable storage area in which the value of the variable to be maintained is stored based on the variable information. The variable information may be, for example, type information 24 indicating a type of each variable, variable update information to be stored in a variable update area 57, or instance information for managing an instance ID or the like. The memory management unit 41 executes address assignment in the variable storage area in which the value of the variable to be changed is stored, stores the second user program in the second execution object area 52, and changes the information stored in the third storage area (management area 59) from information indicating that the first user program is to be executed to information indicating that the second user program is to be executed. Furthermore, the memory management unit 41 writes a predetermined value in the variable whose address has been changed at the break of the logic operation. This would reduce a stop time of the user program.

### [Viewpoint 3]

The variable to be changed may be a variable whose type or size is changed. When the type or size is changed, not only a storage area (address) to be assigned but also storage content (value) is often changed. Thus, address reassignment is executed for the variable whose type or size is changed. Conversely, for a variable whose type and size are maintained, a value is also maintained. That is, address reassignment is unnecessary. This would reduce a stop time of the user program.

### [Viewpoint 4]

The variables may be variables of a structure type. In this case, the variable to be changed may be a variable in which a member included in a structure is added or deleted and a type or a size of the member included in the structure is changed.

### [Viewpoint 5]

The variable to be changed may be a variable whose address for storing the variable is changed.

### [Viewpoint 6]

The variables may include a first global variable and a second global variable. The first global variable is the variable to be maintained, and the second global variable is the variable to be changed. In this case, the memory management unit 41 may maintain an address of the first global variable and assign the second global variable to a free address (address in an unused state) in the data memory.

### [Viewpoint 7]

The variables may include a first local variable and a second local variable. The first local variable is the variable to be maintained, and the second local variable is the variable to be changed. The memory management unit 41 may maintain an address of the first local variable and assign the second local variable to a free address in the data memory.

### [Viewpoint 8]

The first local variable and the second local variable may be local variables included in the function block. The memory management unit 41 may manage an address of the first local variable and an address of the second local variable using an address offset from a head address of the function block.

### [Viewpoint 9]

A first storage area (for example, first execution object area 51) is an area that stores an execution object of the first user program. A second storage area (for example, second execution object area 52) is an area that stores an execution object of the second user program. After the address assignment in the variable storage area for the variable to be changed is completed, a compiling unit 43 may compile the second user program to generate the execution object.

### [Viewpoint 10]

The user program may include a plurality of POUs 25. The compiling unit 43 may recompile only a POU 25 for which recompiling is determined to be necessary among the plurality of POUs 25 to reproduce an execution object. The compiling unit 43 may copy an execution object of a POU 25 for which recompiling is determined not to be necessary among the plurality of POUs 25 from the first user program to the second user program. As a result, the stop time may be shortened. Note that the POU for which recompiling is determined not to be necessary may be referred to as a POU determined not to need to be recompiled.

There is a case where recompiling is necessary even when a variable or a structure definition used by the POU 25 is changed.

[Before Change]
struct ST_A {
mem1: UINT;
mem2: UINT;
} END_STRUCT
[After Change]
TYPE ST A
STRUCT
mem1: ARRAY[0..9] OF UINT;
mem2: UINT;
END_STRUCT;
END_TYPE
[POU (No Editing)]
VAR
var1: ST_A;
END_VAR;
var1.mem2 := 10;

At this time, an offset from a structure head of var1.mem2 changes from 2 bytes to 20 bytes by the change. Thus, it is determined that recompiling of the POU 25 is necessary.

### [Viewpoint 11]

The variable to be maintained may be a variable in which both a name of the variable and a type of the variable are maintained. The memory management unit 41 may maintain a value stored in the variable to be maintained when the first user program is stopped, and cause the second user program to use the value without any change.

### [Viewpoint 12]

The variables may include variables of an array type having two or more dimensions. There is a case where a name of the variables of the array type in the first user program coincides with a name of the variables of the array type in the second user program, the number of dimensions of the variables of the array type in the first user program coincides with the number of dimensions of the variables of the array type in the second user program, and a possible range of element numbers of the variables of the array type in the first user program is different from a possible range of element numbers of the variables of the array type in the first user program. In this case, when a variable with element numbers identical to element numbers of the variable in the variables of the array type in the second user program exists in the variables of the array type in the first user program, the memory management unit 41 may maintain a value of the variable of the array type in the first user program identified by the element numbers as a value of the variable of the array type in the second user program identified by the element numbers. When the variable with the element numbers identical to the element numbers of the variable in the variables of the array type in the second user program does not exist in the variables of the array type in the first user program, the memory management unit 41 may store a predetermined value (for example, initial value) in the variable of the array type in the second user program identified by the element numbers.

### [Viewpoint 13]

There is a case where a type of the variable of the array type in the first user program identified by the element numbers is different from a type of the variable of the array type in the second user program identified by the element numbers and implicit type conversion is possible. In this case, the value may be maintained by the implicit type conversion.

### [Viewpoint 14]

There is a case where the user program including a plurality of function blocks is updated from the first user program to the second user program. In this case, entity information for identifying an entity (instance) of the first function block to be maintained by the update and an entity of the second function block to be changed by the update may be stored in the RAM 37. This entity information (instance information) may be a part of the type information 24. Based on the entity information, the CPU 31 (entity management unit 42) maintains entity identification information (for example, instance ID) of the entity of the first function block in the first user program in the second user program, and maintains an address of the entity of the first function block. An entity management unit 42 may change entity identification information of the entity of the second function block and assign a free address to the entity of the second function block.

### [Viewpoint 15]

There is a case where the second function block exists in both the first user program and the second user program, but a variable included in the second function block is changed. In this case, the entity management unit 42 changes an address assigned with an entity of the second function block in the first user program to an unused state. Furthermore, the entity management unit 42 may assign a free address to an entity of the second function block in the second user program. When the variable is changed, a size of an instance of the function block is also changed in many cases. Therefore, a storage area of such an instance may be released, and the instance may be assigned to an unused area.

### [Viewpoint 16]

There is a case where the second function block is a function block that does not exist in the first user program but is added to the second user program. The entity management unit 42 may assign a free address to an entity of the second function block in the second user program.

### [Viewpoint 17]

There is a case where the second function block is a function block that exists in the first user program, but is deleted from the second user program. In this case, the entity management unit 42 may change an address in which an entity of the second function block in the first user program has been stored to the unused state.

### [Viewpoint 18]

As illustrated in FIG. 11, each of the entity of the first function block and the entity of the second function block in the first user program may be stored in a storage area larger than a size of the entity in advance at the time of online transfer. In this case, a storage area may be assigned to the entity of the second function block in the second user program within the range of the storage area assigned to the entity of the second function block in the first user program. A size and an address of the storage area may be determined or fixed in advance.

### [Viewpoint 19]

When a variable has been added in the second function block, a storage area of the added variable may be assigned within the range of the storage area.

### [Viewpoint 20]

When a variable has been deleted from the second function block, a storage area of the deleted variable may be changed to an unused state within the range of the storage area.

### [Viewpoint 21]

The user program (for example, POU 25) may acquire an address of an object for each entity of a function block and an address of a variable used in the function block using the entity identification information.

### [Viewpoint 22]

There may be provided a control method of a programmable logic controller including: a processor that repeatedly executes a logic operation based on a user program; and a data memory that stores values of variables accessed according to the user program executed by the processor. The control method includes:
receiving an instruction to switch to a second user program, which is an updated version of a first user program, while the processor is executing the first user program;
maintaining an address in the data memory in which a value of a variable to be maintained is stored based on variable information for identifying the variable to be maintained and a variable to be changed by an update from the first user program to the second user program; and
stopping the logic operation and assigning, at a break of the logic operation, an address in the data memory in which a value of the variable to be changed is stored.

### [Viewpoint 23]

A control program 38 stored in a ROM 36 may cause the programmable logic controller to execute the control method of the programmable logic controller described in Viewpoint 22.

The invention is not limited to the above embodiment, and various modifications and changes can be made within a scope of a gist of the invention.

What is claimed is:

1. A programmable logic controller comprising:
a processor configured to repeatedly execute a logic operation based on a user program;
a data memory configured to store values of variables accessed according to the user program executed by the processor; and
a memory management unit configured to maintain an address in the data memory in which a value of a variable to be maintained is stored based on variable information for identifying the variable to be maintained and a variable to be changed by an update from a first user program to a second user program, which is an updated version of the first user program, when an instruction to switch to the second user program is received while the processor is executing the first user program, and to stop the logic operation and assign, at a break of the logic operation, an address in the data memory in which a value of the variable to be changed is stored.

2. The programmable logic controller according to claim 1, further comprising a program memory configured to store the user program, wherein
the program memory includes:
a first storage area that stores the first user program;
a second storage area that stores the second user program; and
a third storage area that stores information indicating either the first user program stored in the first storage area or the second user program stored in the second storage area that is to be executed,
a variable storage area of the data memory in which the values of the variables are stored is a storage area shared by the first user program and the second user program, and
the memory management unit
maintains an address in the variable storage area in which the value of the variable to be maintained is stored and assigns an address in the variable storage area in which the value of the variable to be changed is stored based on the variable information,
stores the second user program in the second storage area,
changes the information stored in the third storage area to information for executing the second user program, and
writes a predetermined value in the variable with the address being changed at the break of the logic operation.

3. The programmable logic controller according to claim 1, wherein the variable to be changed is a variable whose type or size is changed.

4. The programmable logic controller according to claim 1, wherein, in a case where the variables are variables of a structure type, the variable to be changed is a variable in which a member included in a structure is added or deleted and a type or a size of the member included in the structure is changed.

5. The programmable logic controller according to claim 1, wherein the variable to be changed is a variable in which an address for storing the variable is changed.

6. The programmable logic controller according to claim 1, wherein
the variables include a first global variable and a second global variable, the first global variable is the variable to be maintained, and the second global variable is the variable to be changed, and
the memory management unit maintains an address of the first global variable, and assigns the second global variable to a free address in the data memory.

7. The programmable logic controller according to claim 1, wherein
the variables include a first local variable and a second local variable, the first local variable is the variable to be maintained, and the second local variable is the variable to be changed, and
the memory management unit maintains an address of the first local variable, and assigns the second local variable to a free address in the data memory.

8. The programmable logic controller according to claim 7, wherein
the first local variable and the second local variable are local variables included in a function block, and
the memory management unit manages the address of the first local variable and the address of the second local variable using an address offset from a head address of the function block.

9. The programmable logic controller according to claim 2, wherein
the first storage area is an area that stores an execution object of the first user program, and the second storage area is an area that stores an execution object of the second user program, and
the execution object of the second user program is generated by compiling the second user program after completion of the address assignment in the variable storage area for the variable to be changed.

10. The programmable logic controller according to claim 1, wherein
the user program includes a plurality of POUs, and
only a POU for which recompiling is determined to be necessary among the plurality of POUs is recompiled to reproduce an execution object, and an execution object of a POU for which recompiling is determined not to be necessary among the plurality of POUs is copied from the first user program to the second user program.

11. The programmable logic controller according to claim 1, wherein
the variable to be maintained is a variable in which both a name of the variable and a type of the variable are maintained, and
the memory management unit maintains a value stored in the variable to be maintained when the first user program is stopped, and causes the second user program to use the value without any change.

12. The programmable logic controller according to claim 1, wherein
the variables include variables of the array type having two or more dimensions,
in a case where a name of the variables of the array type in the first user program coincides with a name of the variables of the array type in the second user program, a number of dimensions of the variables of the array type in the first user program coincides with a number of dimensions of the variables of the array type in the second user program, and a possible range of element numbers of the variables of the array type in the first user program is different from a possible range of element numbers of the variables of the array type in the first user program,
the memory management unit
maintains a value of a variable of the array type in the first user program identified by element numbers as a value of the variable of the array type in the second user program identified by the element numbers when the variable with the element numbers identical to the element numbers of the variable in the variables of the array type in the second user program exists in the variables of the array type in the first user program, and
stores a predetermined value in the variable of the array type in the second user program identified by the element numbers when the variable with the element numbers identical to the element numbers of the variable in the variables of the array type in the second user program does not exist in the variables of the array type in the first user program.

13. The programmable logic controller according to claim 12, wherein the value is maintained by implicit type conversion in a case where a type of the variable of the array type in the first user program identified by the element numbers is different from a type of the variable of the array type in the second user program identified by the element numbers and the implicit type conversion is possible.

14. The programmable logic controller according to claim 1, further comprising an entity management unit configured to cause entity identification information of an entity of a first function block in the first user program to be maintained in the second user program, to maintain an address of the entity of the first function block, to change entity identification information of an entity of a second function block, and to assign a free address to the entity of the second function block when the user program including a plurality of function blocks is updated from the first user program to the second user program, based on entity information for identifying the entity of the first function block to be maintained by the update and the entity of the second function block to be changed by the update.

15. The programmable logic controller according to claim 14, wherein
when the second function block exists in both the first user program and the second user program but a variable included in the second function block is changed,
the entity management unit
changes an address assigned with the entity of the second function block in the first user program to an unused state, and
assigns a free address to the entity of the second function block in the second user program.

16. The programmable logic controller according to claim 14, wherein
when the second function block does not exist in the first user program but is added to the second user program,
the entity management unit assigns a free address to the entity of the second function block in the second user program.

17. The programmable logic controller according to claim 14, wherein
when the second function block exists in the first user program but is deleted from the second user program,
the entity management unit changes an address in which the entity of the second function block in the first user program has been stored to an unused state.

18. The programmable logic controller according to claim 14, wherein
each of the entity of the first function block and the entity of the second function block in the first user program is stored in a storage area larger than a size of the entity in advance when online transfer is performed, and
a storage area is assigned to the entity of the second function block in the second user program within a range of the storage area assigned to the entity of the second function block in the first user program.

19. The programmable logic controller according to claim 14, wherein the user program acquires an address of an object for each entity of a function block and an address of a variable used in the function block using the entity identification information.

20. A control method of a programmable logic controller including: a processor configured to repeatedly execute a logic operation based on a user program; and a data memory configured to store values of variables accessed according to the user program executed by the processor, the control method comprising:
receiving an instruction to switch to a second user program, which is an updated version of a first user program, while the processor is executing the first user program;
maintaining an address in the data memory in which a value of a variable to be maintained is stored based on variable information for identifying the variable to be maintained and a variable to be changed by an update from the first user program to the second user program; and
stopping the logic operation and assigning, at a break of the logic operation, an address in the data memory in which a value of the variable to be changed is stored.
